(19) United States
(12) Patent Application Publication
(10) Pub. No.: US 2024/0218732 A1
(43) Pub. Date: Jul. 4, 2024

(54) ADHESIVE JOINT BETWEEN WOVEN AND NONWOVEN FABRIC FOR A CELLULAR SHADE

(71) Applicant: Springs Window Fashions, LLC, Middleton, WI (US)

(72) Inventor: Jeffery Lee Hull, SR., Sun Prairie, WI (US)

(21) Appl. No.: 18/399,440

(22) Filed: Dec. 28, 2023

Related U.S. Application Data
(60) Provisional application No. 63/477,755, filed on Dec. 29, 2022.

(51) Int. Cl. E06B 9/262; C09J 5/00

(52) U.S. Cl. CPC E06B 9/262; C09J 5/00; C09J 2400/266; E06B 2009/2625; E06B 2009/2627

(57) ABSTRACT

A cellular shade includes a first, woven fabric material having a first upper surface, a first lower surface, and a first outer edge surface extending between the first upper surface and the first lower surface. The first fabric material has a first thickness as measured between the first upper surface and the first lower surface along a first direction. The cellular shade also includes a second, unwoven fabric material having a second upper surface, a second lower surface, and a second outer edge surface extending between the second upper surface and the second lower surface. The second fabric material has a second thickness as measured between the second upper surface and the second lower surface along the first direction. The first outer edge surface faces the second outer edge surface along a second direction that is perpendicular to the first direction. The cellular shade also includes a layer of adhesive coupled to both the first, woven fabric material and the second, nonwoven fabric material. The layer of adhesive overlaps both the first, woven fabric material and the second, nonwoven fabric material, defining an adhesive joint between the first, woven fabric material and the second, nonwoven fabric material.

### CROSS-REFERENCE TO RELATED APPLICATIONS

This application claims priority to U.S. Application No. 63/477,755, filed Dec. 29, 2022, the entire contents of which is incorporated herein by reference.

### FIELD OF THE DISCLOSURE

The present disclosure relates to a cellular shade, and more specifically to an adhesive joint between a woven and nonwoven fabric material for a cellular shade.

### SUMMARY

In one example of an embodiment, a cellular shade includes a first, woven fabric material having a first upper surface, a first lower surface, and a first outer edge surface extending between the first upper surface and the first lower surface. The first fabric material has a first thickness as measured between the first upper surface and the first lower surface along a first direction. The cellular shade also includes a second, unwoven fabric material having a second upper surface, a second lower surface, and a second outer edge surface extending between the second upper surface and the second lower surface. The second fabric material has a second thickness as measured between the second upper surface and the second lower surface along the first direction. The first outer edge surface faces the second outer edge surface along a second direction that is perpendicular to the first direction. The cellular shade also includes a layer of adhesive coupled to both the first, woven fabric material and the second, nonwoven fabric material. The layer of adhesive overlaps both the first fabric material and the second fabric material, defining an adhesive joint between the first fabric material and the second fabric material.

Other aspects of the disclosure will become apparent by consideration of the detailed description and accompanying drawings.

### BRIEF DESCRIPTION OF THE DRAWINGS

FIG. 1 is a perspective view of an example of a cellular shade.

FIG. 2 is a schematic, top view of a first, woven fabric material of the cellular shade coupled to a second, nonwoven fabric material of the cellular shade with a layer of adhesive.

FIG. 3 is a schematic, cross-sectional view of first fabric material, the second fabric material, and the layer of adhesive, taken along lines 3-3 in FIG. 2.

FIG. 4 is a schematic, cross-sectional view of first fabric material, the second fabric material, and an additional layer of adhesive.

FIG. 5 is a perspective view of a nozzle for applying the layer of adhesive on the first fabric material and the second fabric material.

FIG. 6 is a cross-sectional view of a gear pump for applying the layer of adhesive on the first fabric material and the second fabric material.

FIG. 7 is a perspective, partially transparent view of a progressing cavity pump for applying the layer of adhesive on the first fabric material and the second fabric material.

FIG. 8 is a partial, top view of a swirl pattern used for the layer of adhesive applied on the first fabric material and the second fabric material.

FIG. 9 is a partial, top view of an ultraviolet (UV) gel polish used for the layer of adhesive applied on the first fabric material and the second fabric material.

FIG. 10 is a schematic, top view of a stitch pattern used for the layer of adhesive applied on the first fabric material and the second fabric material.

FIG. 11 is a flow diagram illustrating an example of a process for applying the layer of adhesive to the first fabric material and the second fabric material.

Before any constructions of the disclosure are explained in detail, it is to be understood that the disclosure is not limited in its application to the details of construction and the arrangement of components set forth in the following description or illustrated in the accompanying drawings. The disclosure is capable of supporting other constructions and of being practiced or of being carried out in various ways.

### DETAILED DESCRIPTION

The present disclosure is generally directed to a shade 100 (e.g., a cellular shade) for selectively adjusting a position of a covering relative to an architectural opening in an architectural structure. It should be appreciated that the architectural opening can include any suitable opening in a building or other structure, such as a window, a door, a skylight, and/or an open-air opening. The term window should be construed to include not only a window, but any other suitable architectural opening that the innovation described herein can be used to selectively cover.

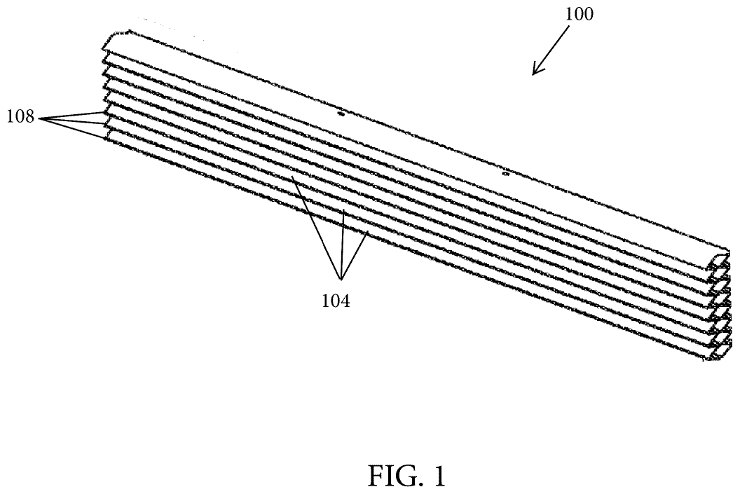

With reference to FIG. 1, in the illustrated example, the shade 100 (or shade material 100) is part of a shade assembly for an architectural opening, such as a window. In other examples, the shade 100 is, for example, part of an assembly that includes at least one cord or other structure that facilitates movement (e.g., vertical movement) and/or expanding and collapsing of the shade 100. The illustrated shade 100 is a cellular shade, and more specifically a cordless cellular shade, with the shade material formed of two different materials. In other examples of embodiments, the shade 100 can be a corded shade, a roller shade, or any other suitable shade that includes a fabric formed of at least two different materials joined (or fastened) in accordance with the joint and associated process described herein.

With continued reference to FIG. 1, the shade 100 includes a plurality of cells 104 (e.g., arranged in a honeycomb pattern or other pattern). Each of the cells 104 is formed from one or more types of fabric, and includes a plurality of folded edges (or pleats) 108 that facilitate expanding and collapsing of the shade 100. In the illustrated example, the shade 100 is a single cell, honeycomb shade 100. In other examples, the shade 100 is a double cell shade, or other type of shade.

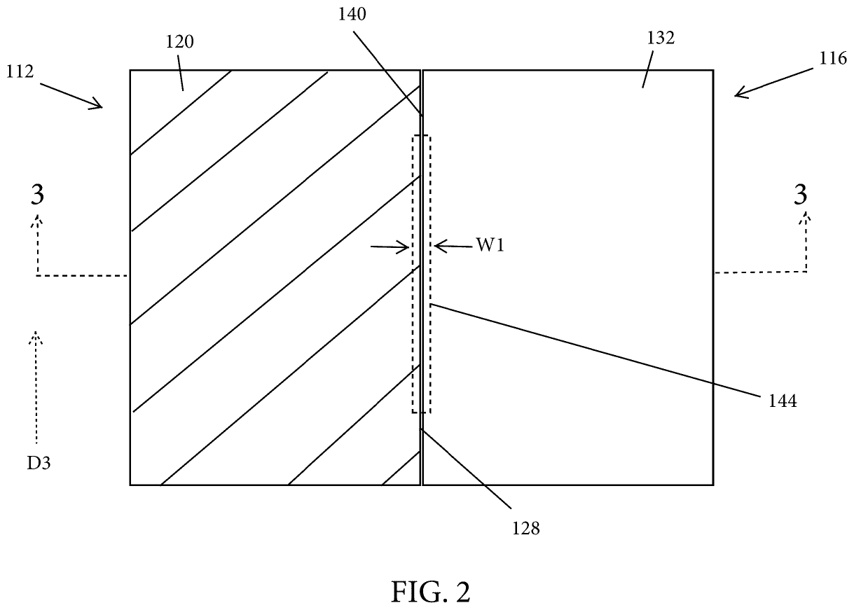

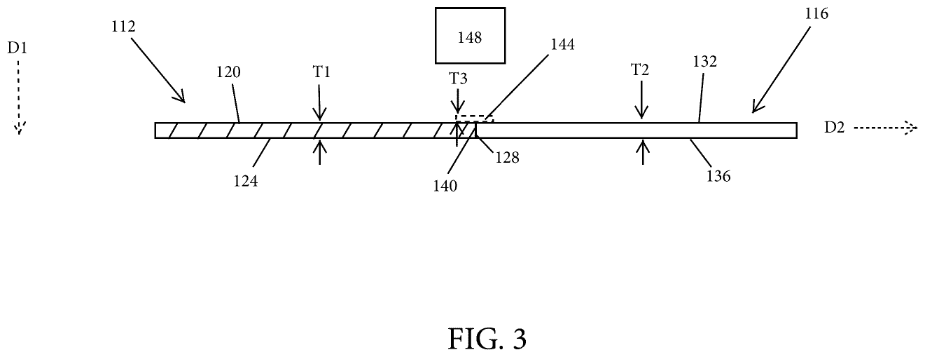

With reference to FIGS. 2 and 3, each of the cells 104 includes a hybrid cellular fabric formed from a first fabric material 112 (e.g., a woven, a woven polyester, a fiber blend, etc.), and a second fabric material 116 (e.g., a nonwoven, a processed staple fiber, a spunbonded nonwoven, a Blackout fabric, etc.). In the illustrated example the first fabric material 112 is an elongate strip of woven material, and the second fabric material 116 is an elongate strip of nonwoven material (or unwoven material). While the illustrated example illustrates a first fabric material 112 that is woven and a second fabric material 116 that is nonwoven, in other examples both the first fabric material 112 and the second fabric material 116 may be woven, or both the first fabric material 112 and the second fabric material 116 may be nonwoven. Additionally, other examples include different sizes and shapes of a first fabric material 112 and a second fabric material 116 than that illustrated (e.g., strips of first fabric material 112 and second fabric material 116 having other shapes and sizes than that illustrated, including examples where the shape or size of the strip of first fabric material 112 is different than the shape or size of the strip of second fabric material 116). It should be appreciated that a nonwoven material can be any textile fabric created by a proves of bonding fibers together, for examples by chemical adhesion, mechanical treatment, heat treatment, a combination thereof, etc. The nonwoven generally does not include weaving of fibers like a woven fabric.

In some examples, the first fabric material 112 is used to form an inwardly-facing portion of the shade 100 (e.g., a colorful, aesthetic portion that is seen from inside the architectural structure), whereas the second fabric material 116 is used to form an outwardly facing portion of the shade 100 (e.g., a portion that directly receives sunlight and faces an outside of the architectural structure). In other examples, the first fabric material 112 and the second fabric material 116 may be each used for either an inwardly-facing portion of the shade 100 or an outwardly facing portion of the shade 100.

As illustrated in FIGS. 2 and 3, the first fabric material 112 includes a first upper surface 120, a first lower surface 124 (shown in FIG. 3), and a first outer edge surface 128 extending between the first upper surface 120 and the first lower surface 124. In the illustrated embodiment, the first outer edge surface 128 (or first edge 128 or first edge surface 128) of the first fabric material 112 is arranged generally perpendicular to the first upper and lower surfaces 120, 124. In some examples, one or more of the first upper surface 120, the first lower surface 124, and the first outer edge surface 128 is planar. In some examples, the first upper surface 120 and the first lower surface 124 each have greater surface area than the first outer edge surface 128. Other examples include other shapes and contours for the first upper surface 120, the first lower surface 124, and the first outer edge surface 128 than that illustrated.

As illustrated in FIG. 3, the first fabric material 112 has a first thickness T1 as measured between the first upper surface 120 and the first lower surface 124 along a first direction D1 (e.g., a vertical direction). The first direction D1 may, for example, be perpendicular to both the first upper surface 120 and the first lower surface 124. The first direction D1 may be parallel to the first edge 128. The first thickness T1 may range, for example between approximately 10 mils (0.010 inches) and approximately 18 mils (0.018 inches), and more specifically between approximately 12 mils (0.012 inches) and approximately 16 mils (0.016 inches). Other examples include different ranges and values. In some examples, the first fabric material 112 may have a constant first thickness T1 moving laterally across the first fabric material 112 (i.e., moving horizontally across the page in FIG. 3, along a second direction D2). In other examples, the first thickness T1 may vary moving laterally across the first fabric material 112 (e.g., may increase or decrease in one or more areas).

With reference to FIGS. 2 and 3, the second fabric material 116 includes a second upper surface 132, a second lower surface 136 (shown in FIG. 3), and a second outer edge surface 140 extending between the second upper surface 132 and the second lower surface 136. In the illustrated embodiment, the second outer edge surface 140 (or second edge 140 or second edge surface 140) of the second fabric material 116 is arranged generally perpendicular to the second upper and lower surfaces 132, 136. In some examples, one or more of the second upper surface 132, the second lower surface 136, and the second outer edge surface 140 is planar. In some examples, the second upper surface 132 and the second lower surface 136 each have greater surface area than the second outer edge surface 140. Other examples include other shapes and contours for the second upper surface 132, the second lower surface 132, and the second outer edge surface 140 than that illustrated.

As illustrated in FIG. 3, the second fabric material 116 has a second thickness T2 as measured between the second upper surface 132 and the second lower surface 136 along the first direction D1. The second thickness T2 may range, for example between approximately 10 mils (0.010 inches) and approximately 18 mils (0.018 inches), and more specifically between approximately 12 mils (0.012 inches) and approximately 16 mils (0.016 inches). Other examples include different ranges and values. In some examples, the second fabric material 116 may have a constant second thickness T2 moving laterally across the second fabric material 116 (i.e., moving horizontally across the page in FIG. 3, along the second direction D2). In other examples, the second thickness T2 may vary moving laterally across the first fabric material 112 (e.g., may increase or decrease in one or more areas).

While the illustrated example shows a first thickness T1 at the first outer edge surface 128 that is identical (or nearly identical to) the second thickness T2 at the second outer edge surface 140, in other examples the first thickness T1 at the first outer edge surface 128 may be different than the second thickness T2 at the second outer edge surface 130. For example, in one embodiment, the first thickness T1 can be at least 10%, 15%, 20%, or 25% larger than the second thickness T2. Stated another way, the first thickness T1 can be approximately 0% to approximately 25% larger, and more specifically approximately 0% to approximately 20% larger than the second thickness T2. As a nonlimiting example, the first fabric material 112 can have a first thickness T1 (or a first caliper T1) of approximately 10 mils (0.010 inches) to approximately 18 mils (0.018 inches). The second fabric material 116 can gave a second thickness T2 (or a second caliper T2) of approximately 10 mils (0.010 inches) to approximately 13.5 mils (0.0135 inches). In another example of an embodiment, the first thickness T1 can be at least 10%, 15%, 20%, or 25% less (or smaller) than the second thickness T2. Stated another way, the first thickness T1 can be approximately 0% to approximately 25% smaller, and more specifically approximately 0% to approximately 20% smaller than the second thickness T2. As a nonlimiting example, the first fabric material 112 can have a first thickness T1 (or a first caliper T1) of approximately 10 mils (0.010 inches) to approximately 13.5 mils (0.0135 inches). The second fabric material 116 can gave a second thickness T2 (or a second caliper T2) of approximately 10 mils (0.010 inches) to approximately 18 mils (0.018 inches). In some examples, the first thickness T1 at the first outer edge surface 128 may be identical (or nearly identical to) the second thickness T2 at the second outer edge surface 140, but the first thickness T1 may be different from the second thickness T2 at locations away from the first outer edge surface 128 and the second outer edge surface 140.

With continued reference to FIGS. 2 and 3, the first outer edge surface 128 faces the second outer edge surface 140 along the second direction D2. In the illustrated example, the second direction D2 is perpendicular to the first direction D1. In some examples, the first outer edge surface 128 physically contacts, and abuts, the second outer edge surface 140 (forming an end-to-end joint or a “butt joint”). In other examples, the first outer edge surface 128 faces the second outer edge surface 140 along the second direction D2, but is separated from the second outer edge surface 140 by a small gap along the second direction D2. The gap may range, for example, between 0 mils and 15 mils (0.015 inches), and more specifically less than 15 mils (0.015 inches). Stated another way, the gap may be not greater than 15 mils (0.015 inches). Other examples include different ranges and values. In some examples, the first outer edge surface 128 is aligned with (e.g., parallel to) the second outer edge surface 140.

With continued reference to FIGS. 2 and 3, a layer of adhesive 144 is applied to both the first fabric material 112 and the second fabric material 116. The layer of adhesive 144 overlaps both the first fabric material 112 and the second fabric material 116, defining an adhesive joint (or adhesive end-to-end joint or adhesive butt-joint) between the first fabric material 112 and the second fabric material 116. In the illustrated example, the layer of adhesive 144 is applied to and covers at least a portion of both the first upper surface 120 and the second upper surface 132. In some examples, the layer of adhesive 144 can extend over both the first outer edge surface 128 and the second outer edge surface 140, and through any gap between the first outer edge surface 128 and the second outer edge surface 140.

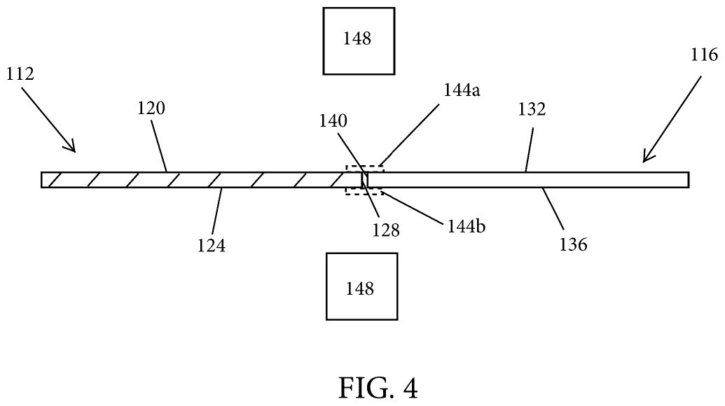

With reference now to FIG. 4, in another example of an embodiment, the layer of adhesive 144 may be applied to a portion of both the first lower surface 124 and the second lower surface 136. More specifically, a first layer of adhesive 144a may be applied to a portion of both the first upper surface 120 and the second upper surface 132. A second layer of adhesive 144b may be applied to a portion of both the first lower surface 124 and the second lower surface 136. In some examples, the layer of adhesive 144 may extend entirely through any gap between the first outer edge surface 128 and the second outer edge surface 140, such that the layer of adhesive reaches both the first upper surface 120, the second upper surface 132, the first lower surface 124, and the second lower surface 136.

With reference back to FIG. 2, the layer of adhesive 144 may extend (e.g., generally linearly) along both the first fabric material 112 and the second fabric material 116, for at least a portion of both the first fabric material 112 and the second fabric material 116. In some examples, the layer of adhesive 144 extends entirely from one end to the other of both the first fabric material 112 and the second fabric material 116.

The layer of adhesive 144 has a width W1, that may remain constant, or may change and deviate along the layer. In the illustrated example, the width W1 remains generally constant, and is approximately ⅛ inch in width. Stated another way, the width W1 extends approximately 1/16 inch of width over the first fabric material 112 and approximately 1/16 inch of width over the second fabric material 116. In some examples, the width W1 is within a range of between 1/16 inch and 3/16 inch, or between 1/16 inch and ¼ inch. Other examples include different ranges and values of the width W1.

With reference to FIG. 3, the layer of adhesive 144 also has a thickness T3. The thickness T3 is measured above the first upper surface 120 and the second upper surface 132 of the fabric materials 112, 116. The thickness T3 may remain constant or may change and deviate. In the illustrated example, the thickness T3 remains generally constant throughout the layer of adhesive 144, and remains at approximately 0.005 inches (or 5 mils), or between approximately 0.004 inches (or 4 mils) and approximately 0.006 inches (or 6 mils), or between approximately 0.003 inches (or 3 mils) and approximately 0.007 inches (or 7 mils). Other examples include different ranges and values of thickness.

In some examples, after application of the adhesive 144, only a portion (e.g., less than 50%) of the adhesive applied remain positioned on top of the first upper surface 120 and/or the second upper surface 132. The remaining adhesive may be absorbed into the fibers of the first fabric material 112 and/or the second fabric material 116. Accordingly, the thickness T3 may represent only a portion of the adhesive that is actually binding the first fabric material 112 and the second fabric material 116 together. In some examples, approximately 20% of the adhesive 144 may be positioned on top of the first upper surface 120 and/or the second upper surface 132, while the remaining approximately 80% of the adhesive 144 may be absorbed into the fibers (or absorbed into the materials 112, 116). In other examples, approximately 30% of the adhesive 144 may be positioned on top, while approximately 70% may be absorbed into the fibers. In yet other examples, approximately 40% may be positioned on top, while approximately 60% may be absorbed into the fibers. Other examples include different values and ranges of values.

With continued reference to FIGS. 3 and 4, the layer of adhesive 144 (or layers 144a, 144b) may be applied, for example, with one or more adhesive applicators 148 during formation of the shade 100. For example, the adhesive applicator 148 may be positioned above both the first outer edge surface 128 and the second outer edge surface 140, such that as the first fabric material 112 and the second fabric material 116 are moved along a direction D3 (shown in FIG. 2), the adhesive may be released onto, or otherwise applied over, both the first fabric material 112 an the second fabric material 116 at a location of both the first outer edge surface 128 and the second outer edge surface 140. The adhesive may be applied at a predetermined rate (e.g., 40 cc/minute, between 35 cc/minute and 45 cc/minute, between 30 cc/minute and 50 cc/minute, or other ranges and values). Additionally, the first fabric material 112 and the second fabric material 116 may be moved along the direction D3 at a speed of approximately 1.88 meters/second, or approximately 2 meters/second, or between 1.5 meters/second and 2.5 meters/second. Other examples include other ranges and values.

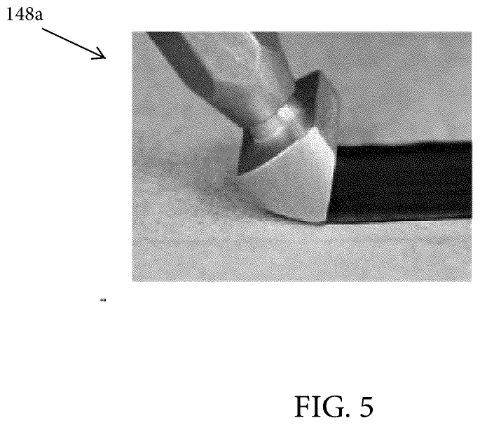

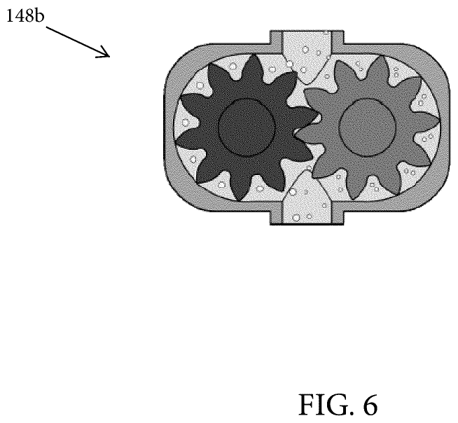

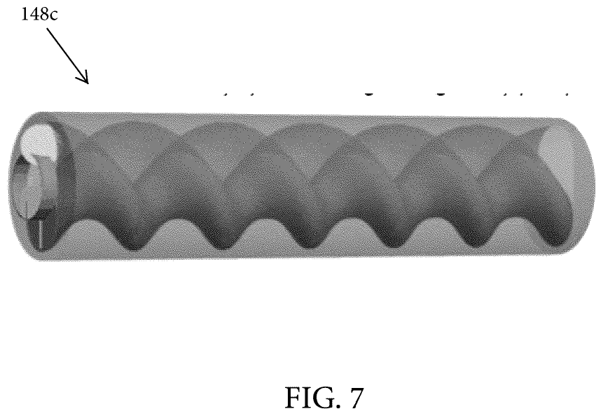

With reference to FIG. 5, the adhesive applicator 148 may be any of a number of different types of applicators, and include any of a number of components for dispensing and/or applying adhesive. For example, an adhesive applicator 148a includes a nozzle. The nozzle can include a slot nozzle that both applies and spreads the adhesive to define the width W1. Adhesive can be supplied to the adhesive applicator 148, such as the nozzle 148a, with a pump. The pump is configured to transport the adhesive, which has viscosity greater than water. For example, with reference to FIG. 6, the pump can include a gear pump that is configured to transport the adhesive to the adhesive applicator 148. As another example, and with reference to FIG. 7, the pump can include a progressing cavity pump that is configured to transport the adhesive to the adhesive applicator 148.

The type of adhesive used for the layer of adhesive 144 may be any of a number of adhesives. In some examples, the adhesive is a color neutral adhesive that blends with the fabric material (e.g., so as not to be visible and considered a defect). The adhesive may be a polyurethan reactive (PUR) adhesive, or an ultraviolet (UV) cure adhesive, such as a UV gel polish, or other type of adhesive. In some examples, the adhesive is an ultraviolet (UV) activated adhesive, such that the adhesive cures in response to exposure to ultraviolet (UV) light. For example, UV light at 405 nm wavelength, or in the range of 365-425 nm wavelength (or other wavelengths) can be applied to the adhesive after application to cure the adhesive. Additionally, the adhesive may have any of a number of viscosities. In some examples, the adhesive has a viscosity of between approximately 30,000-45,000 centipoise, although other examples include different ranges and values.

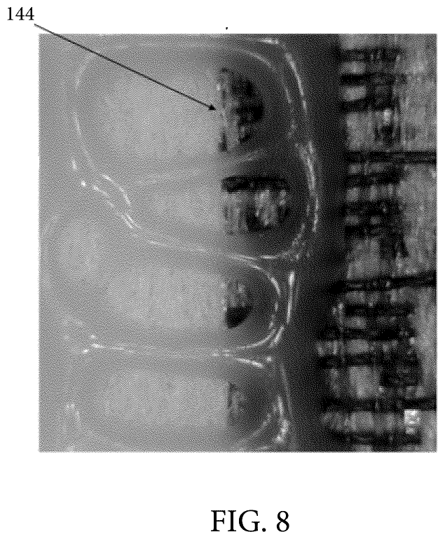

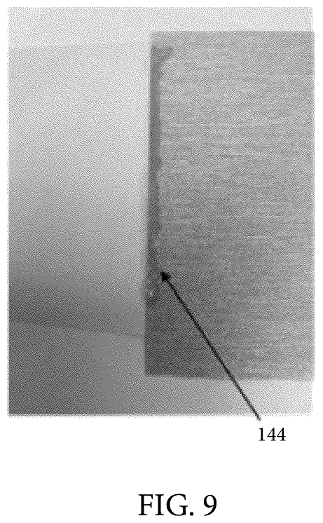

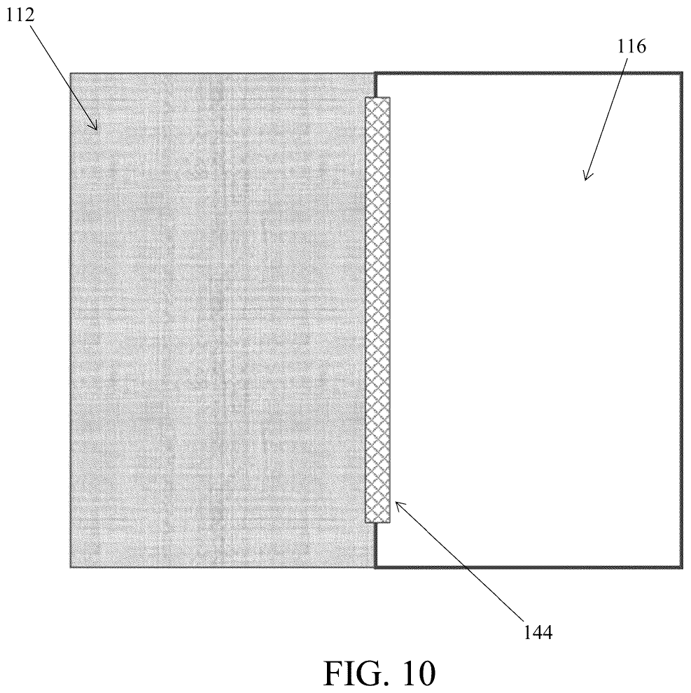

The adhesive may also be applied in a variety of different patterns, continuously or intermittently. For example, in the examples illustrated in FIGS. 2-4, the adhesive is applied continuously and linearly. In another example illustrated in FIG. 8, the adhesive for the adhesive layer 144 may be applied a swirl pattern. In other examples, and with reference to FIG. 9, the adhesive may be applied in a solid, or generally solid, pattern. In other examples, and with reference to FIG. 10, the adhesive may be applied in a geometric stitch pattern.

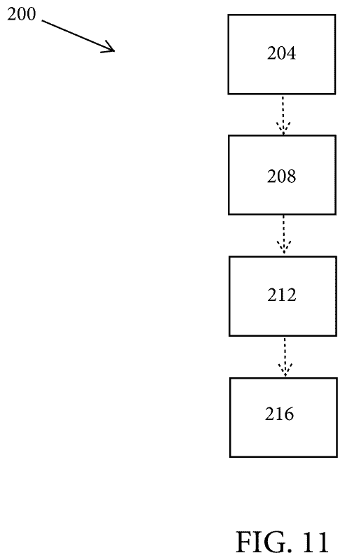

With reference to FIG. 11, a process 200 for forming the shade 100 may include a first step 204 of selecting the first fabric material 112 and the second fabric material 116. Once selected, the process proceeds with aligning the edge surfaces 128, 140 of the fabric materials 112, 116. The first outer edge surface 128 of the first fabric material 112 and the second outer edge surface 140 of the second fabric material 116 are aligned so that the first outer edge surface 128 and the second outer edge surface 140 are physically contacting one another, forming an end-to-end joint. In some embodiments, the edge surfaces 128, 140 can be separated by a small gap. During this step, the first fabric material 112 and/or the second fabric material 116 may also be tension adjusted to facilitate the alignment. For example, each of the fabric materials 112, 116 can be provided in a roll format. As the fabric materials 112, 116 are aligned, they can be unwound or otherwise adjusted for alignment. Since the fabric materials 112, 116 can include materials, and can have different physical properties, the amount of tension applied to each fabric material 112, 116 during aligning of the edge surfaces 128, 140 can be different.

Once the fabric materials 112, 116 are aligned such that the edge surfaces 128, 140 are in contact to form the end-to-end joint, the process proceeds to applying the adhesive 144. At second step 208, the layer of adhesive 144 (or layer(s) of adhesive 144) is applied over the first fabric material 112 and the second fabric material 116 at the location of the first outer edge surface 128 and the second outer edge surface 140. The layer of adhesive 144 is applied by the adhesive applicator 148 (e.g., with a slot nozzle 148a). Application of the layer of adhesive 144 results in adhesive being applied to both the first fabric material 112 and the second fabric material 116, the adhesive overlaps the end-to-end joint formed by the edge surfaces 128, 140. The process 200 includes a third step 212 of activating and/or curing the adhesive. The applied layer of adhesive 144 is exposed to a UV light (e.g., passing the applied adhesive and joined fabric materials 112, 116 under at least one UV light (or a bank of UV lights)). Once the layer of adhesive 144 is cured, the end-to-end joint is formed. The joined fabric materials 112, 116 can be now further processed for use in a window shade. For example, a fourth step 216 of forming a cellular shade material with the joined fabric materials 112, 116 can include forming a honeycomb geometry for the cellular shade by utilizing hot melt.

Overall, the positioning of the first fabric material 112 and its first outer edge surface 128 with the second fabric material 116 and its second outer edge surface 140, in combination with the applied layer of adhesive 144, may facilitate an overall reduction in thickness (e.g., stack height) of the shade 100 as compared to other shades. For example, as seen in FIG. 3, and as described above, the first outer edge surface 128 faces the second outer edge surface 140. Accordingly, there is no overlap of the first fabric material 112 and the second fabric material 116 where the first fabric material 112 is joined to the second fabric material 116. Only the thickness of the adhesive layer 144 itself adds to the overall thickness of the combined fabric materials. If an overlap existed, the overall height would be increased for each cell 104 of shade 100. Accordingly, when the cells 104 collapse and are stacked together (e.g., when the shade 100 is raised vertically to the top of a window), the overall thickness, or stack height, of the shade 100 may remain reduced, providing a low profile, as compared to a shade 100 where the first fabric material 112 and the second fabric material 116 overlap.

Additionally, the positioning of the first fabric material 112 and its first outer edge surface 128 with the second fabric material 116 and its second outer edge surface 140, in combination with the applied layer of adhesive 144, may also facilitate a fabric stack that compresses well for cut to length and route hole drilling.

Overall, the arrangement described above may also provide light control, and privacy improvement with light filtering or blackout characteristics, and/or may provide a cost impact, with use of lower cost high-end woven styles and colors. The arrangement may also provide improved strength (e.g., improved cross-directional strength to be resistant to sudden impacts and premature failure), and/or may allow the shade 100 to be color-neutral to the street (e.g., as required by neighborhood associations). In some embodiments, the hybrid arrangement may also include minimal pleat usage and pleat flexibility (e.g., to allow shade drop length and function with a cordless mechanism).

Various features and advantages of the disclosure are set forth in the following claims.

What is claimed is:

1. A cellular shade comprising:
a first, woven fabric material having a first upper surface, a first lower surface, and a first outer edge surface extending between the first upper surface and the first lower surface, wherein the first fabric material has a first thickness as measured between the first upper surface and the first lower surface along a first direction;
a second, unwoven fabric material having a second upper surface, a second lower surface, and a second outer edge surface extending between the second upper surface and the second lower surface, wherein the second fabric material has a second thickness as measured between the second upper surface and the second lower surface along the first direction, wherein the first outer edge surface faces the second outer edge surface along a second direction that is perpendicular to the first direction; and
a layer of adhesive coupled to both the first fabric material and the second fabric material, wherein the layer of adhesive overlaps both the first fabric material and the second fabric material, defining an adhesive joint between the first fabric material and the second fabric material.

2. The cellular shade of claim 1, wherein the first outer edge surface is in physical contact with the second outer edge surface.

3. The cellular shade of claim 1, wherein the first outer edge surface is separated by the second outer edge surface by a gap.

4. The cellular shade of claim 1, wherein the layer of adhesive extends over both a portion of the first upper surface and a portion of the second upper surface.

5. The cellular shade of claim 1, wherein the first thickness is identical to the second thickness.

6. The cellular shade of claim 1, wherein the first thickness is different than the second thickness.

7. The cellular shade of claim 1, wherein the first thickness is between 10 mils and 18 mils, and wherein the second thickness is between 10 mils and 18 mils.

8. The cellular shade of claim 1, wherein the layer of adhesive has a width of between 1/16 inch and 3/16 inch.

9. The cellular shade of claim 1, wherein the layer of adhesive has a thickness of between 0.003 inches and 0.007 inches.

10. The cellular shade of claim 1, wherein the layer of adhesive includes adhesive configured to be activated by ultraviolet light.

11. The cellular shade of claim 10, wherein the layer of adhesive includes adhesive configured to be activated by ultraviolet light within a range of 365-425 nm.

12. The cellular shade of claim 1, wherein the layer of adhesive includes adhesive with a viscosity of between 30,000-45,000 centipoise.

13. The cellular shade of claim 1, wherein the first upper surface and the first lower surface each have greater surface area than the first outer edge surface.

14. The cellular shade of claim 1, wherein the cellular shade is a single cell, honeycomb shade.

15. A method of forming a cellular shade comprising:
selecting a first fabric material and a second fabric material;
aligning a first outer edge surface of the first fabric material with a second outer edge surface of the second fabric material, such that the first outer edge surface faces the second outer edge surface; and
applying a layer of adhesive over the first fabric material and the second fabric material at a location of the first outer edge surface and the second outer edge surface, such that the layer of adhesive overlaps both the first fabric material and the second fabric material.

16. The method of claim 15, wherein the step of aligning includes physically contacting the first outer edge surface with the second outer edge surface.

17. The method of claim 15, wherein the step of aligning includes adjusting a tension of the first fabric material and adjusting a tension of the second fabric material.

18. The method of claim 15, wherein the step of applying the layer of adhesive includes applying the layer of adhesive with a slot nozzle.

19. The method of claim 15, further comprising a step of applying ultraviolet light to cure the layer of adhesive.

20. The method of claim 15, wherein the first fabric material has a thickness of between 0.010 inches and 0.018 inches, wherein the second fabric material has a thickness of between 0.010 inches and 0.018 inches, and wherein the layer of adhesive has a thickness of between 0.003 and 0.007 inches.
